(19) United States
(12) Patent Application Publication
(10) Pub. No.: US 2009/0259579 A1
(43) Pub. Date: Oct. 15, 2009

(54) SYSTEM AND METHOD FOR TRANSFERRING MONETARY VALUE BETWEEN CURRENCY DOCUMENTS

(75) Inventor: Hanns-Christian Leemon Hanebeck, Carrollton, TX (US)

Correspondence Address: CANTOR COLBURN LLP - IBM AUSTIN, 20 Church Street, 22nd Floor, Hartford, CT, 06103, US

(73) Assignee: International Business Marchines Corp, Armonk, NY (US)

(21) Appl. No.: 12/099,962

(22) Filed: Apr. 9, 2008

(51) Int. Cl. G06Q 40/00

(52) U.S. Cl. 705/35

(57) ABSTRACT

A system and a method for transferring monetary value between first and second currency documents are provided. The method includes reading a first RFID tag on the first currency document to obtain a first monetary value stored in the first RFID tag, utilizing a first RFID scanning device. The method further includes selecting a transfer value that is less than or equal to the first monetary value, utilizing a first computer. The first computer operably communicates with the first RFID scanning device. The method further includes sending the transfer value from the first computer to a second computer. The method further includes reading a second RFID tag on the second currency document to obtain a second monetary value stored in the second RFID tag, utilizing a second RFID scanning device. The second RFID scanning device operably communicates with the second computer. The method further includes determining a third monetary value for the second currency document, by adding the transfer value to the second monetary value. The method further includes writing the third monetary value to the second RFID tag on the second currency document, utilizing the second RFID scanning device.

### FIELD OF INVENTION

This application relates to a system and a method for transferring monetary value between currency documents having radio-frequency identification (RFID) tags.

### BACKGROUND OF INVENTION

A currency document, such as a U.S. dollar bill, has a predetermined monetary value of one dollar listed thereon. However, the monetary value of the U.S. dollar bill, cannot be transferred to another U.S. dollar bill. Thus, only the party in physical possession of the U.S. dollar bill can utilize it in commerce. Further, if the party wants to immediately pay for a good or service from a vendor physically remote from the party, the party is not able to utilize the U.S. dollar bill to do so.

Accordingly, the inventor herein has recognized a need for a system and a method for transferring monetary value between currency documents.

### SUMMARY OF INVENTION

A method for transferring monetary value between first and second currency documents in accordance with an exemplary embodiment is provided. The method includes reading a first RFID tag on the first currency document to obtain a first monetary value stored in the first RFID tag, utilizing a first RFID scanning device. The method further includes selecting a transfer value that is less than or equal to the first monetary value, utilizing a first computer. The first computer operably communicates with the first RFID scanning device. The method further includes sending the transfer value from the first computer to a second computer. The method further includes reading a second RFID tag on the second currency document to obtain a second monetary value stored in the second RFID tag, utilizing a second RFID scanning device. The second RFID scanning device operably communicates with the second computer. The method further includes determining a third monetary value for the second currency document, by adding the transfer value to the second monetary value. The method further includes writing the third monetary value to the second RFID tag on the second currency document, utilizing the second RFID scanning device. The method further includes displaying the third monetary value on a first display device on the second currency document. The first display device operably communicates with the second RFID tag.

A system for transferring monetary value between first and second currency documents in accordance with another exemplary embodiment is provided. The system includes a first RFID scanning device configured to read a first RFID tag on the first currency document to obtain a first monetary value stored in the first RFID tag. The system further includes a first computer operably communicating with the first RFID scanning device. The first computer is configured to select a transfer value that is less than or equal to the first monetary value, based on an inputted value. The first computer is further configured to send the transfer value to a second computer. The system further includes a second RFID scanning device configured to read a second RFID tag on the second currency document to obtain a second monetary value stored in the second RFID tag. The second RFID scanning device operably communicates with the second computer. The second computer is configured to determine a third monetary value for the second currency document, by adding the transfer value to the second monetary value. The second RFID scanning device is configured to write the third monetary value to the second RFID tag on the second currency document such that a first display device on the second currency document displays the third monetary value. The first display device operably communicates with the second RFID tag.

### BRIEF DESCRIPTION OF DRAWINGS

FIG. 1 is a schematic of a system for transferring monetary value between currency documents in accordance with an exemplary embodiment;

FIG. 2 is a schematic of an exemplary currency document having an RFID tag;

FIG. 3 is a schematic of the RFID tag utilized in the currency document of FIG. 2;

FIG. 4 is a schematic of another exemplary currency document having an RFID tag;

FIG. 5 is a schematic of the RFID tag utilized in the currency document of FIG. 4; and

FIGS. 6 and 7 are flowcharts of a method for transferring monetary value between currency documents having RFID tags in accordance with another exemplary embodiment.

### DESCRIPTION OF EXEMPLARY EMBODIMENTS

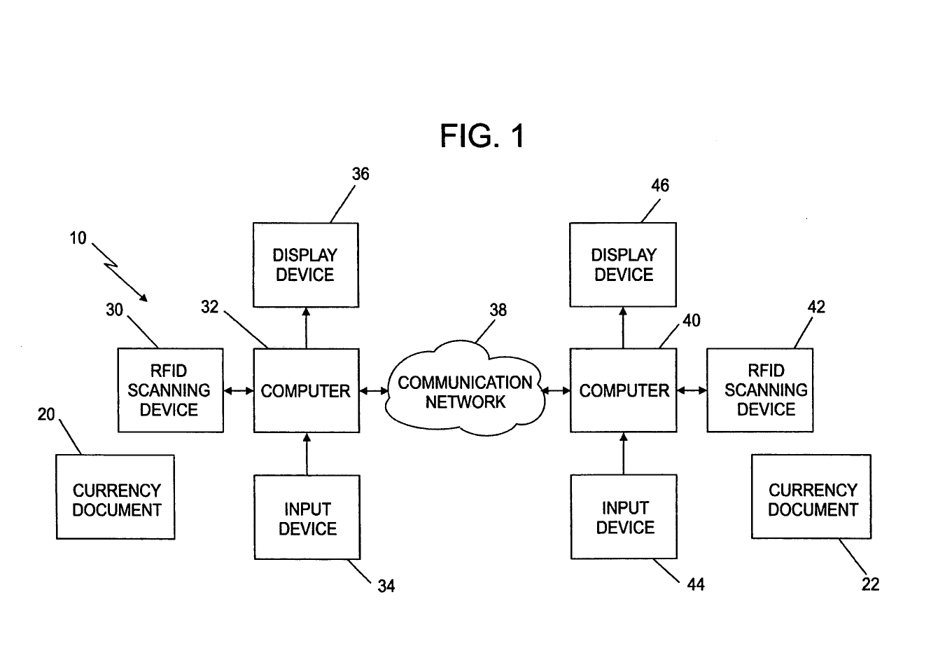

Referring to FIG. 1, a system 10 for transferring monetary value between currency documents 20, 22 is illustrated. The system includes a RFID scanning device 30, a computer 32, an input device 34, a display device 36, a communication network 38, a computer 40, a RFID scanning device 42, an input device 44, and a display device 46. An advantage of the system 10 is that the system 10 can electronically transfer a monetary value between the currency document 20 and the currency document 22.

The currency documents 20 and 22 have monetary values that are utilized in commerce by users to purchase goods or services. As will be discussed in further detail below, the currency documents 20, 22 each have RFID tags that can be utilized by the system 10 to transfer a monetary value between the currency documents 20, 22. This type of functionality is particular useful for purchasing goods or services where a purchaser is physically remote from a vender of goods or services.

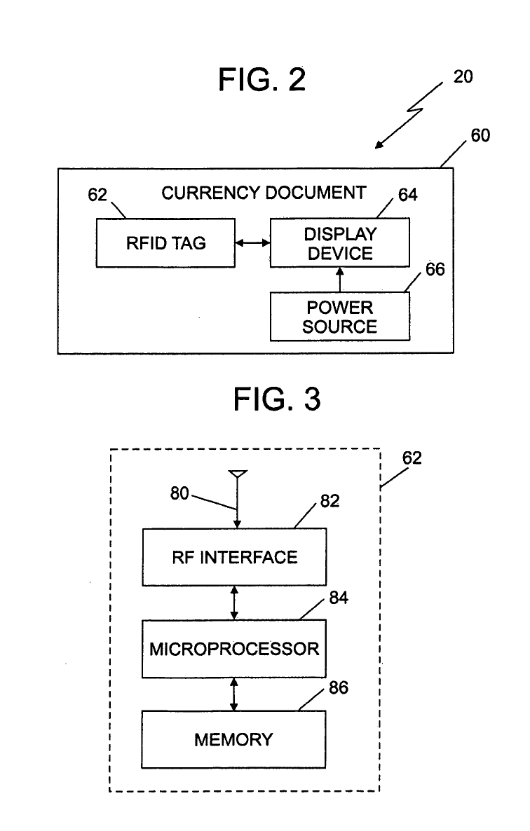

Referring to FIGS. 2 and 3, in one exemplary embodiment, the currency document 20 includes a pliable fabric 60 having a human readable text thereon, an RFID tag 62, a display device 64 and a power source 64. The RFID tag 62 is provided to store data indicating a monetary value therein and is attached to the pliable fabric 60. In an exemplary embodiment, the RFID tag 62 is a passive RFID tag and includes an antenna 80, an RF interface 82, microprocessor 84, and a memory 86. In an alternative embodiment, the RFID tag 62 is an active RFID tag. The RF interface 82 is configured to receive an RF signal utilizing the antenna 80 and to send commands and data within the RF signal to the microprocessor 84. In one exemplary embodiment, the RF interface 82 is further configured to generate an operational voltage from received RF signals that is utilized by the microprocessor 84. The microprocessor 84 is configured to receive the commands and data from the RF interface 82 and to execute software subroutines based upon the commands and data. For example, if the received command is a read command, the microprocessor 84 can retrieve a monetary value stored in the memory 86 and induce the RF interface 82 to transmit an RF signal having the monetary value therein. If the received command is a write command and the data is a new monetary value, the microprocessor 84 can write the monetary value to the memory 86. It should be further noted that the currency document 20 has a unique serial number stored in the memory 86 of the RFID tag 62. The display device 64 is operably coupled to the microprocessor 84 of the RFID tag 62 and to the power source 66. The display device 64 is physically coupled to the pliable fabric 60. The microprocessor 84 is configured to induce the display device 64 to display a monetary value stored in the memory 86 of the RFID tag 62. Further, the power source 66 is configured to supply an operational voltage to the display device 64, and optionally to the RFID tag 62 when the RFID tag 62 is an active RFID tag. The display device 64 can comprise a LCD display device, a LED display device, or a holographic display device for example.

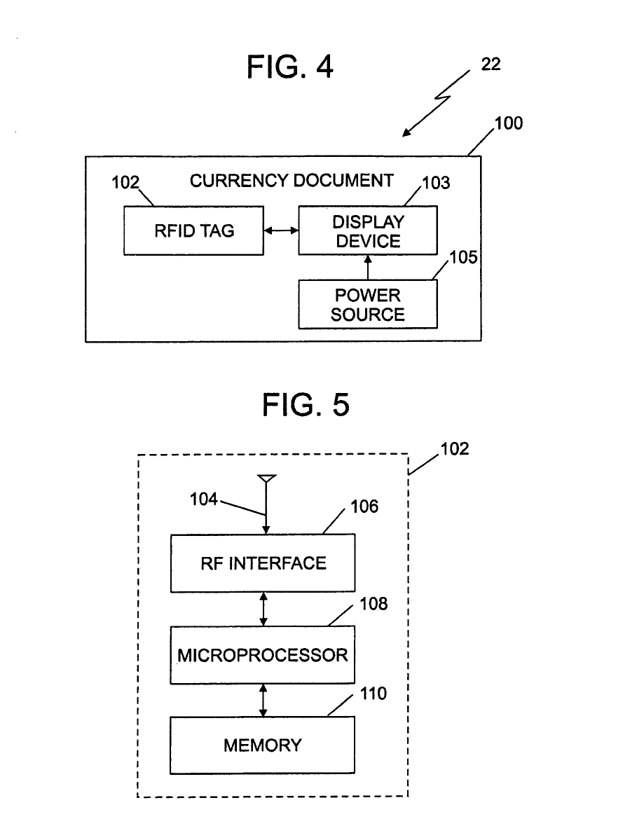

Referring to FIGS. 4 and 5, the currency document 22 includes a pliable fabric 100 having a human readable text thereon, an RFID tag 102, a display device 103, and a power source 105. The RFID tag 102 is provided to store data indicating a monetary value therein and is physically attached to the pliable fabric 100. In an exemplary embodiment, the RFID tag 102 is a passive RFID tag and includes an antenna 104, an RF interface 106, a microprocessor 108, and a memory 110. In an alternative embodiment, the RFID tag 102 is an active RFID tag. The RF interface 106 is configured to receive an RF signal utilizing the antenna 104 and to send commands and data within the RF signal to the microprocessor 108. In one exemplary embodiment, the RF interface 106 is further configured to generate an operational voltage from received RF signals that is utilized by the microprocessor 108. The microprocessor 108 is configured to receive the commands and data from the RF interface 106 and to execute software subroutines based upon the commands and data. For example, if the received command is a read command, the microprocessor 108 can retrieve a monetary value stored in the memory 110 and induce the RF interface 106 to transmit an RF signal having the monetary value therein. If the received command is a write command and the data is a new monetary value, the microprocessor 108 can write the new monetary value to the memory 110. It should be further noted that the currency document 22 has a unique serial number stored in the memory 110 of the RFID tag 102. The display device 103 is operably coupled to the microprocessor 108 of the RFID tag 102 and to the power source 105. The display device 103 is physically coupled to the pliable fabric 100. The microprocessor 108 is configured to induce the display device 103 to display a monetary value stored in the memory 110 of the RFID tag 102. Further, the power source 105 is configured to supply an operational voltage to the display device 103, and optionally to the RFID tag 102 when the RFID tag 102 is an active RFID tag. The display device 103 can comprise a LCD display device, a LED display device, or a holographic display device for example.

Referring to FIG. 1, the RFID scanning device 30 is provided to transmit RF signals having read or write commands and data to the RFID tag 62 in the currency document 20. For example, the RFID scanning device 30 can transmit an RF signal having a read command to the RFID tag 62. Thereafter, the RFID scanning device 30 can receive an RF signal from the RFID tag 62 having data indicating a monetary value stored in the RFID tag 62. Further, the RFID scanning device 30 can transmit an RF signal having a write command and a monetary value to the RFID tag 62 to induce the RFID tag 62 to write the new monetary value to the memory 86 to store the new monetary value in the memory 86.

The computer 32 operably communicates with the RFID scanning device 30, the display device 36, the input device 34, and the communication network 38. For example, in one exemplary embodiment, the computer 32 receives data from the RFID scanning device 30 indicating a first monetary value stored in the RFID tag 62. In response to the received data, the computer 32 induces the display device 36 to display the first monetary value associated with the RFID tag 62 in the currency document 20. Further, the computer 32 induces the display device 36 to display a query message querying a user as to whether the user desires to transfer a transfer value corresponding to at least a portion of the first monetary value of the currency document 20 to another party. If the user inputs inputted data via the input device 34 indicating the user desires to transfer the portion of the first monetary value, the computer 32 determines a second monetary value for the first currency document by subtracting the transfer value from the first monetary value. Further, the computer 32 induces the RFID scanning device 30 to transmit an RF signal having a write command and data indicating the second monetary value to the currency document 20, to update the monetary value of the currency document 20. Still further, the computer 32 sends data having the transfer value to the computer 40 associated with the other party, via the communication network 38. It should be noted that a computer as used herein is defined as any device capable of performing a logical or an arithmetic operation. For example, the computer 32 can comprise at least one of a personal data assistant (PDA), a cell phone, and a hand-held computer.

The communication network 38 is provided to transmit data between the computers 32, 40. The communication network 38 comprises any network capable of transmitting data between computers. For example, the communication network 38 can comprise at least one of a hardwired network, a wireless network, and a combination of thereof.

The RFID scanning device 42 is provided to transmit RF signals having read and write commands and data to the RFID tag 102 in the currency document 22. For example, the RFID scanning device 42 can transmit an RF signal having a read command to the RFID tag 102. Thereafter, the RFID scanning device 42 can receive an RF signal from the RFID tag 102 having data indicating a monetary value stored in the RFID tag 102. Further, the RFID scanning device 42 can transmit an RF signal having a write command and a new monetary value to the RFID tag 102 to induce the RFID tag 102 to write the new monetary value to the memory 110 to store the monetary value in the memory 110.

The computer 40 operably communicates with the communication network 38, the RFID scanning device 42, the display device 46, and the input device 44. For example, in one exemplary embodiment, the computer 42 receives the transfer value from the computer 32 via the communication network 38. Further, the computer 40 induces the display device 46 to display the transfer value thereon. Further, the computer 40 receives data from the RFID scanning device 42 indicating a third monetary value stored in the RFID tag 102 of the currency document 22. In response to the received data, the computer 40 induces the display device 46 to display the third monetary value associated with the RFID tag 102. Further, the computer 40 induces the display device 36 to display a query message querying a user as to whether the user desires to credit the currency document 22 with the transfer value. If the user inputs inputted data via the input device 44 indicating the user desires to credit the currency document 22 with the transfer value, the computer 40 determines a fourth monetary value for the currency document 22 by adding the third monetary value to the transfer value. Further, the computer 40 induces the RFID scanning device 42 to transmit an RF signal having a write command and data indicating the fourth monetary value to the currency document 22, to update the monetary value of the currency document 22. For example, the computer 40 can comprise at least one of a personal data assistant (PDA), a cell phone, and a hand-held computer.

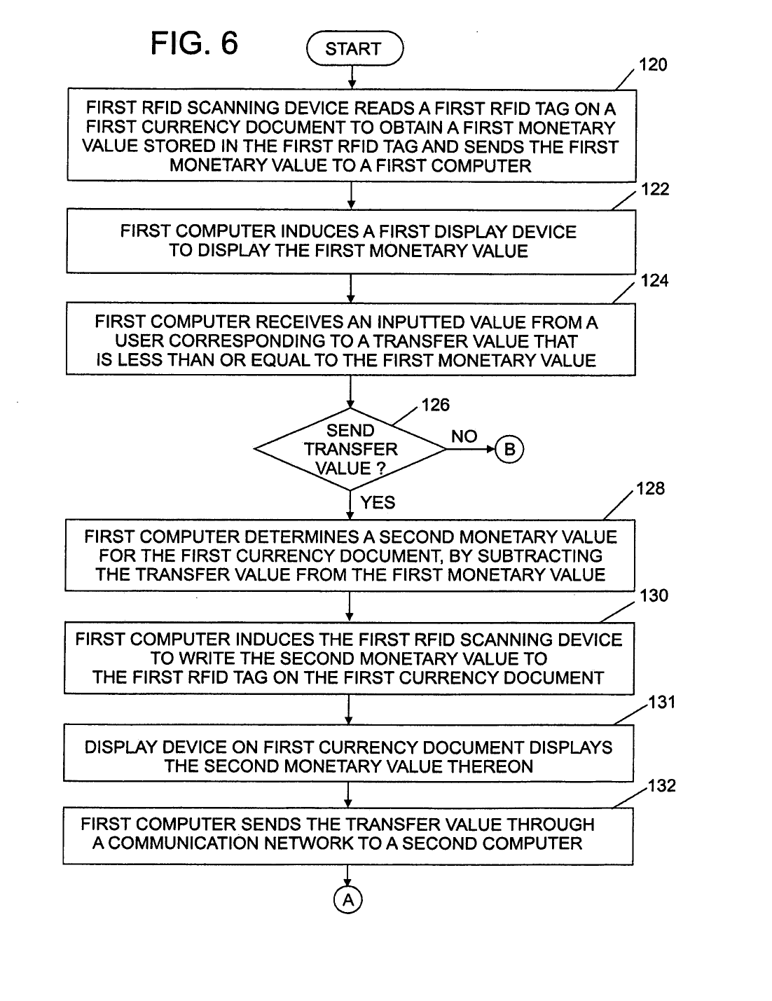

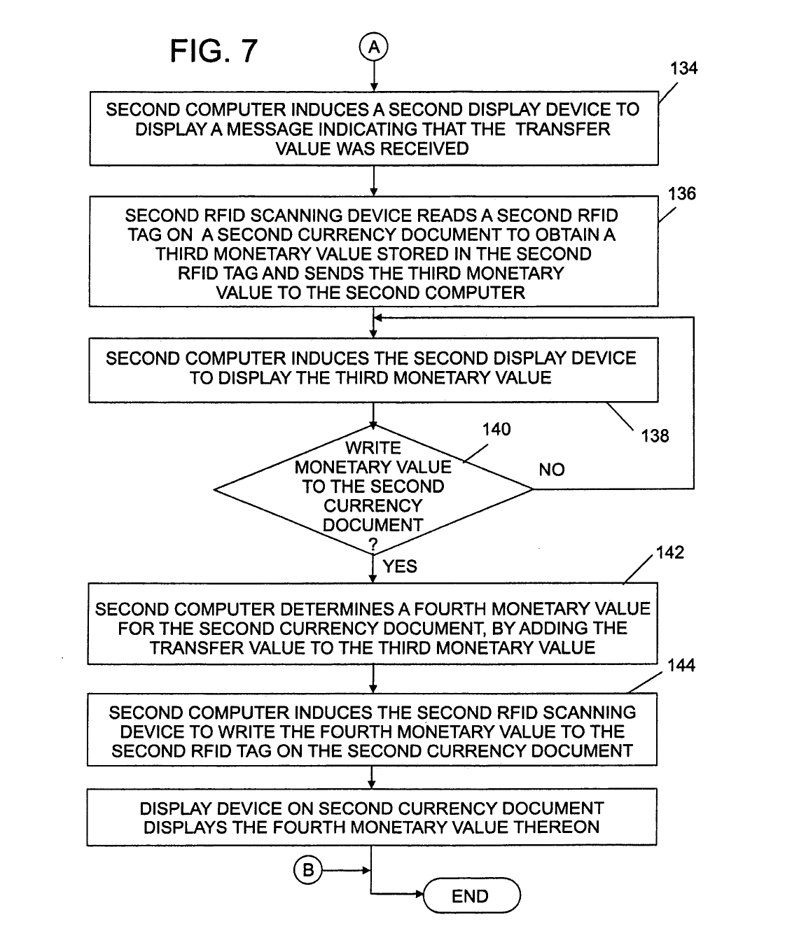

Referring to FIGS. 6 and 7, a flowchart of a method for transferring monetary value between currency documents will now be explained.

At step 120, the RFID scanning device 30 reads the RFID tag 62 on the currency document 60 to obtain a first monetary value stored in the RFID tag 62 and sends the first monetary value to the computer 32.

At step 122, the computer 32 induces the display device 36 to display the first monetary value.

At step 124, the computer 32 receives an inputted value from a user corresponding to a transfer value that is less than or equal to the first monetary value.

At step 126, the computer 32 makes a determination as to whether the user desires to send the transfer value to the computer 40, based on inputted information from the input device 34. If the value of step 126 equals “yes”, the method advances to step 128. Otherwise, the method is exited.

At step 128, the computer 32 determines a second monetary value for the currency document 20, by subtracting the transfer value from the first monetary value.

At step 130, the computer 32 induces the RFID scanning device 30 to write the second monetary value to the RFID tag 62 on the currency document 20.

At step 131, the display device 64 on the currency document 20 displays the second monetary value thereon.

At step 132, the computer 32 sends the transfer value through the communication network 38 to the computer 40.

At step 134, the computer 40 induces the display device 46 to display a message indicating that the transfer value was received.

At step 136, the RFID scanning device 42 reads the RFID tag 102 on the currency document 22 to obtain a third monetary value stored in the RFID tag 102 and sends the third monetary value to the computer 40.

At step 138, the computer 40 induces the display device 46 to display the third monetary value.

At step 140, the computer 40 makes a determination as to whether the user desires to write the third monetary value to the currency document 22, based on inputted information via the input device 44. If the value of step 140 equals “yes”, the method advances to step 142. Otherwise, the method returns to step 138.

At step 142, the computer 40 determines a fourth monetary value for the second currency document, by adding the transfer value to the third monetary value.

At step 144, the computer 40 induces the RFID scanning device 42 to write the fourth monetary value to the RFID tag 102 on the currency document 22. After step 144.

At step 145, the display device 103 on the currency document 22 displays the fourth monetary value thereon. After step 145, the method is exited.

The system and the method for transferring monetary value between currency documents represent a substantial advantage over other systems and methods. In particular, the system and the method provide a technical effect of allowing a user to transfer monetary value from a first currency document to a second currency document remote from the first currency document and to view an updated monetary value on the second currency document.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. A method for transferring monetary value between first and second currency documents, comprising:
reading a first RFID tag on the first currency document to obtain a first monetary value stored in the first RFID tag, utilizing a first RFID scanning device;
selecting a transfer value that is less than or equal to the first monetary value, utilizing a first computer, the first computer operably communicating with the first RFID scanning device;
sending the transfer value from the first computer to a second computer;
reading a second RFID tag on the second currency document to obtain a second monetary value stored in the second RFID tag, utilizing a second RFID scanning device, the second RFID scanning device operably communicating with the second computer;
determining a third monetary value for the second currency document, by adding the transfer value to the second monetary value;
writing the third monetary value to the second RFID tag on the second currency document, utilizing the second RFID scanning device; and
displaying the third monetary value on a first display device on the second currency document, the first display device operably communicating with the second RFID tag.

2. The method of claim 1, further comprising displaying the first monetary value on a second display device operably communicating with the first computer.

3. The method of claim 1, wherein sending the transfer value from the first computer to the second computer, comprises sending the transfer value from the first computer through a communication network to the second computer.

4. The method of claim 1, further comprising displaying the second monetary value on a second display device operably communicating with the second computer.

5. The method of claim 1, further comprising:
determining a fourth monetary value for the first currency document, by subtracting the transfer value from the first monetary value; and
writing the fourth monetary value to the first RFID tag on the first currency document, utilizing the first RFID scanning device.

6. The method of claim 5, further comprising displaying the fourth monetary value on a second display device on the first currency document.

7. The method of claim 1, wherein the first currency document comprises a pliable fabric, the first RFID tag being attached to the pliable fabric.

8. The method of claim 7, wherein the pliable fabric of the first currency document has human-readable currency information thereon.

9. A system for transferring monetary value between first and second currency documents, comprising:
a first RFID scanning device configured to read a first RFID tag on the first currency document to obtain a first monetary value stored in the first RFID tag;
a first computer operably communicating with the first RFID scanning device, the first computer configured to select a transfer value that is less than or equal to the first monetary value, based on an inputted value, the first computer further configured to send the transfer value to a second computer;
a second RFID scanning device configured to read a second RFID tag on the second currency document to obtain a second monetary value stored in the second RFID tag, the second RFID scanning device operably communicating with the second computer;
the second computer configured to determine a third monetary value for the second currency document, by adding the transfer value to the second monetary value;
the second RFID scanning device configured to write the third monetary value to the second RFID tag on the second currency document such that a first display device on the second currency document displays the third monetary value, the first display device operably communicating with the second RFID tag.

10. The system of claim 9, further comprising a second display device configured to display the first monetary value, the second display device operably communicating with the first computer.

11. The system of claim 9, further comprising a communication network, wherein the first computer is configured to send the transfer value through the communication network to the second computer.

12. The system of claim 9, further comprising a second display device configured to display the second monetary value, the second display device operably communicating with the second computer.

13. The system of claim 9, wherein the first computer is further configured to determine a fourth monetary value for the first currency document, by subtracting the transfer value from the first monetary value, the first RFID scanning device further configured to write the fourth monetary value to the first RFID tag on the first currency document.

14. The system of claim 13, wherein the first currency document further includes a second display device operably coupled to the first RFID tag, the first RFID tag configured to induce the second display device to display the fourth monetary value thereon.

15. The system of claim 9, wherein the first currency document comprises a pliable fabric, the first RFID tag being attached to the pliable fabric.

16. The system of claim 15, wherein the pliable fabric of the first currency document has human-readable currency information thereon.
